(19) United States
(12) Patent Application Publication
(10) Pub. No.: US 2025/0346170 A1
(43) Pub. Date: Nov. 13, 2025

(54) TRUCK BED MOUNTED CARRIER SYSTEM

(71) Applicant: Richard Douglas Starr, Florence, AZ (US)

(72) Inventor: Richard Douglas Starr, Florence, AZ (US)

(21) Appl. No.: 19/204,824

(22) Filed: May 12, 2025

Related U.S. Application Data
(60) Provisional application No. 63/646,628, filed on May 13, 2024.

(51) Int. Cl. B60P 1/32; B60P 1/04; B60P 1/12; B60P 1/22; B60P 7/08

(52) U.S. Cl. CPC B60P 1/32; B60P 1/12; B60P 1/22; B60P 1/045; B60P 7/08; B60Y 2200/14

(57) ABSTRACT

A truck bed mounted carrier system includes a frame assembly installable in a truck bed with lateral supports and outer main supports, inner supports that slide within the outer main supports, a center outer support, and a second inner support that slides within the center outer support. A carrier frame coupled to the frame assembly extends from and retracts into the truck bed, supported by radius supports that provide structural integrity when extended. The system features a pulley assist mechanism with gas springs that creates a counterbalance force, a mechanical drive assembly with sprocket and roller chain for movement control, and deployable transport stands for ground support during loading operations. Adjustable bed rail struts with locking mechanisms secure the system to the truck bed without permanent modification. Low-friction materials and strategically positioned slides ensure smooth operation throughout the extension and retraction cycles.

### CROSS REFERENCE TO RELATED APPLICATIONS

This application claims benefit from currently pending U.S. Provisional Application No. 63/646,628 titled “TRUCK BED MOUNTED CARRIER SYSTEM” and having a filing date of May 13, 2025, all of which is incorporated by reference herein.

### FIELD OF THE INVENTION

The present invention pertains to the field of vehicle accessory systems, particularly to a truck bed carrier system designed to easily load and securely transport various recreational and outdoor equipment such as bicycles, kayaks, and other items and more specifically, this invention relates to a versatile and adaptable truck bed carrier system that provides a safe, efficient, and space-saving solution for the transportation of these items.

### BACKGROUND OF THE INVENTION

Outdoor enthusiasts often require a reliable means of transporting recreational equipment, such as bicycles, kayaks, camping gear, and other items, to their preferred destinations. One common approach to achieving this is through the use of roof racks and hitch-mounted carriers. While these systems have been available for some time and offer certain advantages, they are not without their limitations and drawbacks. Roof-mounted or rack carriers, for example, require users to lift and secure heavy and unwieldy equipment onto the roof of their vehicles or onto the rack which is in the bed of the truck, which can be both physically demanding and pose risks to the user's safety. Additionally, roof-mounted and rack carriers can adversely affect a vehicle's aerodynamics, leading to increased fuel consumption, wind noise, and reduced overall vehicle efficiency.

Hitch-mounted carriers, on the other hand, provide an alternative but still present challenges. They can obstruct rear visibility, limit access to the vehicle's trunk or tailgate, and may require an additional trailer hitch installation. Furthermore, existing truck bed carrier systems are often designed for specific purposes, limiting their versatility. For instance, a carrier designed solely for bicycles may not be suitable for carrying kayaks or other types of equipment, resulting in the need for multiple carrier systems or cumbersome modifications to accommodate different items.

There is a need, therefore, for an improved truck bed carrier system that offers versatility, ease of use, and efficient transportation of a wide range of outdoor and recreational equipment. Such a system should be easy to install and remove, provide secure attachment of items, and minimize the impact on vehicle performance and convenience.

The present invention addresses these, and other limitations associated with prior art truck bed carrier systems by providing a novel and adaptable solution for safely transporting bicycles, kayaks, and various other items in the bed of a pickup truck. This invention offers a convenient, space-saving, and versatile solution for outdoor enthusiasts and travelers seeking to transport their equipment securely and efficiently.

### BRIEF SUMMARY OF THE INVENTION

The present invention provides a truck bed mounted carrier system that enables users to efficiently load, unload, and transport cargo without the need to climb into the truck bed. The system features a sliding carrier frame that extends from and retracts into the truck bed, supported by a robust frame assembly with telescoping components. In one embodiment, the system includes a frame assembly with lateral supports and outer main supports that create a stable foundation within the truck bed. Inner supports slide within the outer main supports, allowing for extension beyond the truck bed. A center outer support connects the lateral supports, and a second inner support slides within the center outer support, providing additional extension capability. The carrier frame, which holds the cargo, is coupled to the frame assembly and configured to extend smoothly from the truck bed. Radius supports connect the inner supports to the carrier frame, providing structural integrity when the system is extended. This curved design efficiently distributes load forces throughout the system.

Various mechanisms enhance the system's functionality. A pulley assist mechanism with gas springs creates a counterbalance force, making extension and retraction easier even when loaded with heavy cargo. A mechanical drive assembly with a sprocket, roller chain, and adjustable handle provides mechanical advantage for moving the carrier. A dedicated lifting mechanism enables vertical positioning of the cargo. For stability during loading and unloading, the system includes deployable transport stands that provide ground support when extended. These stands feature a locking mechanism to secure them in the deployed position and are height-adjustable to accommodate various truck heights and terrain conditions.

The system attaches to the truck bed through adjustable rail struts with a specialized locking mechanism that secures the upper rail strut to the lower rail strut. This adjustability allows the system to fit trucks of different makes and models without permanent modification to the vehicle. Low-friction materials coat sliding surfaces to ensure smooth operation, while various slides and rollers guide the movement of components. The entire system is designed for durability in outdoor environments while maintaining user-friendly operation.

This invention provides significant advantages over existing cargo management solutions by combining structural stability, mechanical advantage, adjustability, and ease of operation in a comprehensive system that can be installed in virtually any pickup truck bed.

It is an object of the invention to allow the user to easily load and unload various heavy items in and out of the bed of a truck.

It is another object of the invention to allow the user to easily remove the truck bed mounted carrier system from the bed of the truck and store the truck bed mounted carrier system.

It is another object of the invention to allow the user to safely secure the accessories in the back for the bed of the truck.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 is an isometric view of the truck bed mounted carrier system installed into a bed of a truck in accordance to one, or more embodiments;

FIG. 2 is an isometric view of the truck bed mounted carrier system shown in its partially extended state from the truck bed in accordance to one, or more embodiments;

FIG. 3 is an isometric view of the truck bed mounted carrier system shown in its fully extended state from a truck bed in accordance to one, or more embodiments;

FIG. 4 is a cross-sectional view of the first gear for truck bed mounted carrier system in accordance to one, or more embodiments;

FIG. 5 is a cross-sectional view of the second gear of the truck bed mounted carrier system in accordance to one, or more embodiments;

FIG. 6 is a cross-sectional view of the stationary section of the truck bed mounted carrier system in accordance to one, or more embodiments;

FIG. 7 is a side view of the first gear reduction of the truck bed mounted carrier system in accordance to one, or more embodiments;

FIG. 8 is a side view of the second gear reduction of the truck bed mounted carrier system in accordance to one, or more embodiments;

FIG. 9 is a side view of the lever gear reduction in its various states for the truck bed mounted carrier system in accordance to one, or more embodiments;

FIG. 10 is an isometric view of the truck bed mounted carrier system in its closed position omitting some components in accordance to one, or more embodiments;

FIG. 11 is an isometric view of the truck bed mounted carrier system in its closed position omitting some components in accordance to one, or more embodiments;

FIG. 12 is an isometric view of the truck bed mounted carrier system in its closed position omitting the truck bed in accordance to one, or more embodiments;

FIG. 13 is an isometric view of the truck bed mounted carrier system in its closed position omitting some components in accordance to one, or more embodiments;

FIG. 14 is an isometric view of the truck bed mounted carrier system in its closed position installed in truck bed in accordance to one, or more embodiments;

FIG. 15 is an isometric view of the truck bed mounted carrier system in its partially extended position installed in a truck bed in accordance to one, or more embodiments;

FIG. 16 is an isometric view of the truck bed mounted carrier system in its extended position installed in bed of a truck in accordance to one, or more embodiments;

FIG. 17a is a side view of the carrier system of the forward end for the truck bed mounted carrier system in accordance to one, or more embodiments;

FIG. 17b is a front view of the carrier system of the aft end for the truck bed mounted carrier system in accordance to one, or more embodiments;

FIG. 17c is a front view of the carrier system for the truck bed mounted carrier system in accordance to one, or more embodiments;

FIG. 18a is a top view of pulley assist in the closed position for the truck bed mounted carrier system in accordance to one, or more embodiments;

FIG. 18b is a top view of pulley assist in the extended position for the truck bed mounted carrier system in accordance to one, or more embodiments;

FIG. 19a is a side view of the sprocket and handle for the truck bed mounted carrier system in accordance to one, or more embodiments;

FIG. 19b is a front side view of the lever handler for the truck bed mounted carrier system in accordance to one, or more embodiments;

FIG. 19c is a close-up view of the sprocket gear for the truck bed mounted carrier system in accordance to one, or more embodiments;

FIG. 19d is a close-up frontview of the sprocket gear for the truck bed mounted carrier system in accordance to one, or more embodiments;

FIG. 20a is a side view of a truck connection for the truck bed mounted carrier system in accordance to one, or more embodiments;

FIG. 20b is a closeup view of FIG. 20a of inner support lock tube for the truck bed mounted carrier system in accordance to one, or more embodiments;

FIG. 21a is a side view of the least one radius support and inner support in its closed position for the truck bed mounted carrier system in accordance to one, or more embodiments;

FIG. 21b is a side view of the least one radius support and inner support in its extended position for the truck bed mounted carrier system in accordance to one, or more embodiments;

FIG. 21c is a front view of the least one radius support and inner support for the truck bed mounted carrier system in accordance to one, or more embodiments;

FIG. 22a is a side view of a second inner support and outer support for the truck bed mounted carrier system in accordance to one, or more embodiments;

FIG. 22b is a close-up view of FIG. 22a of a second inner support and outer support for the truck bed mounted carrier system in accordance to one, or more embodiments;

FIG. 23 is a side view of the gas spring and cable system for the truck bed mounted carrier system in accordance to one, or more embodiments;

FIG. 24 is a counterbalance force table for the truck bed mounted carrier system in accordance to one, or more embodiments;

FIG. 25 is a side view of the operator's lever for the truck bed mounted carrier system in accordance to one, or more embodiments;

FIG. 26 is a side view of the support system for the truck bed mounted carrier system in accordance to one, or more embodiments;

FIG. 27 is a close-up view of the support system for the truck bed mounted carrier system in accordance to one, or more embodiments;

FIG. 28 is a front view of the support system for the truck bed mounted carrier system in accordance to one, or more embodiments;

FIG. 29a is a side view of a second inner support and outer support for the truck bed mounted carrier system in accordance to one, or more embodiments;

FIG. 29b is a closeup side view of a second inner support and outer support and release for the truck bed mounted carrier system in accordance to one, or more embodiments; and

FIG. 29c is a closeup side view of a second inner support and outer support and release for the truck bed mounted carrier system in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

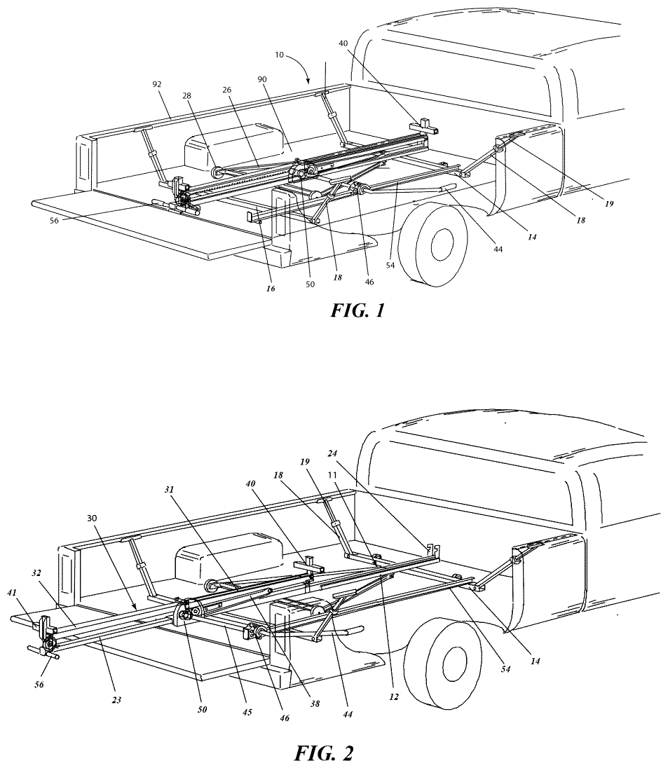

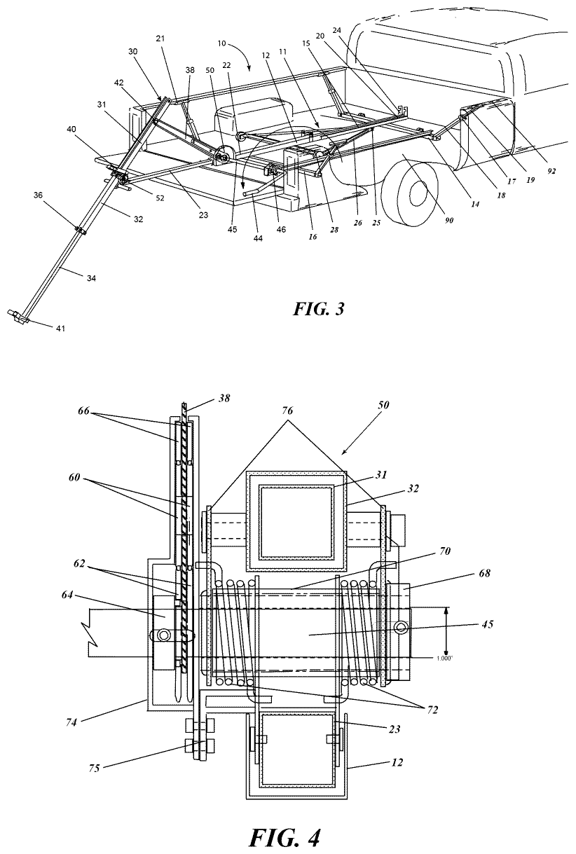

Referring to FIGS. 1-6 shows a truck bed mounted carrier system generally at 10 wherein the truck bed mounted carrier system can be coupled to a bed and a top railing of a truck 94. The carrier system 10 can be permanent or removably coupled to the truck bed 90 and the top railing 92 of the truck 94, providing a secure and stable platform for the transportation of goods which can be such as, for example, kayaks, canoes, bicycles, camping gear, hunting gear, sports equipment, or the like. The truck bed mounted carrier system 10 can comprise a stationary section 11 and a movable section 30. The main member 12 serves as the primary structural component of the stationary section 11, providing stability and support for the entire carrier system.

The stationary section 11 of the truck bed mounted carrier system 10 can comprise a main member 12 that can be coupled to a front bed member 14 and a back bed member 16 by such as, for example, fastener, weld, rivet, or the like. The main member 14 can be at least one tube but in other embodiments the main member can be more than one tube allowing a second main member 15 which can slide within the main housing. The main member 12 and second main member 15 can be such as, for example, a square tube, rectangular tube, circular tube, or the like which can be hollow or solid tubing or can have at least one side open such as u-channel or v-channel. The front bed member 14 and the back bed member 16 can be such as, for example, a square tube, rectangular tube, circular tube, or the like and can partially or fully extend the width of the truck bed 90. The second main member 15 can slide within the main member 12 wherein in certain embodiments the main member can have at least one roller on the top or bottom side which can allow the main member to slide easily on the second main member.

The front bed member 14 and the back bed member 16 can be rotatably coupled to at least one top rail member 18 wherein the front bed member and the back bed member can have a top rail member attached to each side of each member. The top rail member 18 can be slidably coupled to the top rail attachment 19 wherein the top rail attachment can slide within the top rail member allowing the user to extend the top rail attachment to varying widths and depths of trucks. The top rail member 18 can secure the top rail attachment 19 in place and keep it from sliding by a clamp 17 which can be such as, for example, tube clamp, locking pin, set screw, quick release clamp, compression fitting, or the like. The top rail attachment 19 can be removably coupled to the top railing 92 by extending the top rail attachment 19 from the top rail member 18 and applying pressure against the top rail. The top rail attachment 19 can be coupled to an attachment member 21 wherein the attachment member can be such as, for example, angle iron, u-channel, or the like. The main member 12, front bed member 14, back bed member 16, top rail member 18, and top rail attachment 19 can be made from at least one of such as, for example, aluminum, carbon steel, stainless steel, plastic, ceramics, or the like and can be anodized, powder coated or the like.

The main member of the stationary section has a front end and a back end. The front end of the main member has at least one latch, providing a secure means of attaching items to the carrier system. The back end of the main member is slidably coupled to an extension member, allowing for the extension of the carrier system to accommodate larger items. The main member is also slidably coupled to a first gear. The stationary section 11 can further comprise a handle slide member 54 wherein the handle slide member can be coupled to the front bed member 14 and the back bed member 16 by such as, for example, fasteners, weld, rivets, adhesive or the like. The handle slide member 54 can be such as, for example, h-bar, I-beam, c-channel, u-channel or the like. The handle slide member 54 can be on one side of the front bed member 14 and back bed member 16 or can be on both sides of the front bed member and back bed member.

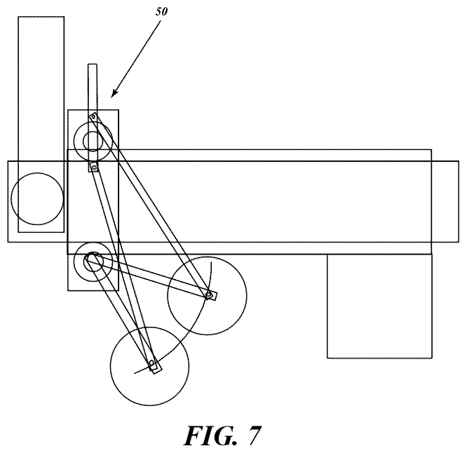

The movable section 30 of the truck bed mounted carrier system 10 can comprises a first movable member 31 that can be slidably coupled to a second movable member 32. A lever 38 can be rotatably coupled to the first movable section 31 on one end of the lever and rotatably coupled to a first gear 50 which is coupled to the back end 22 of the main member 12. The first gear 50 can be a combination of planetary gears 60, sun gears, tanged hub collar to spur gears 64, or the like, as shown in FIG. 4. In the preferred embodiment, the first gear 50 can have planetary gear 60 coupled to the sun gear 62 coupled to the spur gear 64 which can be coupled to a handle arm 45. The first gear 50 can have a housing 74 that can house the gears and partially houses at least on collar with set screw 68 which can be coupled to the lever 38. A support tube 70 can partially encapsulate the handle arm 45 wherein at least one radial torsional spring 72 can be coupled to at least one translation lever 76. The gear housing 74 can be coupled to a gear housing mounting plate 75. An exemplary embodiment of the first gear 50 and how it works is shown in FIG. 7.

The first movable member 31 and the second movable member 32 can be moved relative to each other. The second movable member 32 can have third movable member 34 that can move relative to the second moveable member wherein the third movable member can extend and retract from the second moveable member. The third movable member 34 can be coupled to a second carrier adapter 41 on its end wherein the third movable member and the second carrier adapter can be such as, for example, welded or fastened together. The second movable member 32 can be coupled to a second clamp 36 wherein the second clamp can be such as, for example, tube clamp, locking pin, set screw, quick release clamp, compression fitting, or the like. The second clamp 36 can allow the third movable member 34 to be locked in various positions to allow the user to set the distance for from the truck bed 90 to the ground or the size of the item being placed in the truck bed.

A first carrier adapter 40 can be coupled to at least one of the first gear, second moveable member 32 or first movable member. The first carrier adapter 40 and the second carrier adapter 41 can allow difference accessories to be attached to hold the different items. An extension member 23 can be removably coupled to the second movable member 32 or first gear 50 wherein the extension member can slide in and out of the main member 12. The extension member 23 can be such as, for example, square tube, rectangular tube, circular tube, solid tube or beam, or the like. The first gear 50 can move along the main member 12, providing a means of adjusting the position of the carrier system 10. The first gear 50 is operatively connected to the handle 44 by a handle arm 45, allowing for the rotation of the handle to result in the movement of the first gear along the main member 12. This gear arrangement provides a mechanical advantage that allows for the easy adjustment of the position of the carrier system.

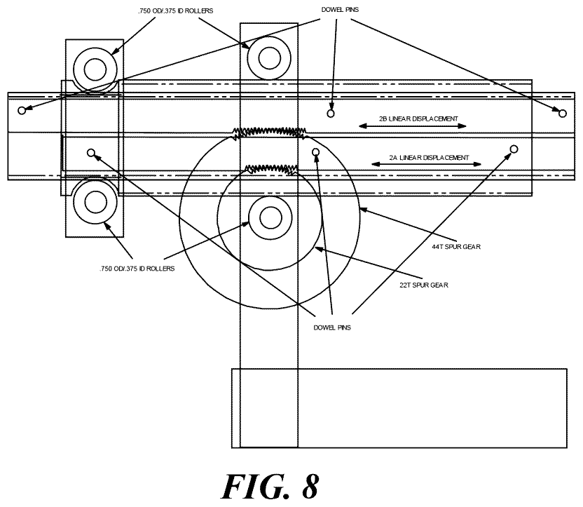

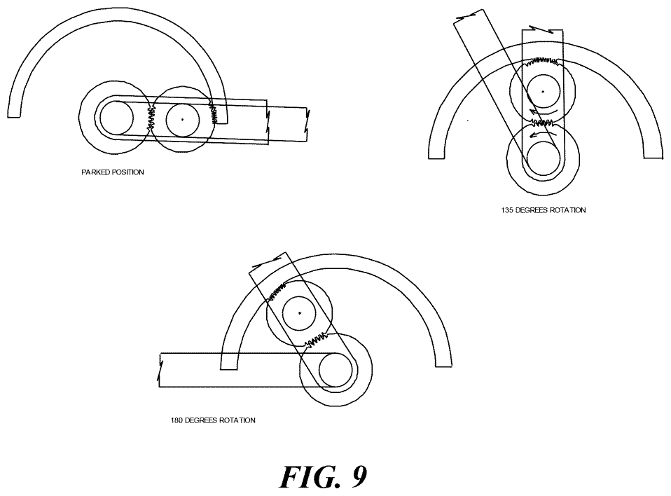

A handle 44 can be coupled to the lever 38, providing a user-friendly means of operating the lever and controlling the movement of the movable section. The handle 44 can move the lever 38 by a handle arm 45. The handle arm 45 allows the handle to be placed away from the moveable section wherein the handle arm can be coupled to and rotate about a handle joint 46. The handle joint 46 can be couple to the handle slide member 54 wherein the handle 44, handle joint can slide along the handle slide member 54. The handle 44 can be such as, for example, lever handle, crank handle, or the like. The lever 38 provides a means of controlling the movement of the movable section 30, allowing for adjustments to be made to the size and position of the carrier system 10. The handle is coupled to the lever 3 can provide a user-friendly means of operating the lever and controlling the movement of the movable section 30. An exemplary embodiment of the lever 38 in its various positions is as shown in FIG. 8, shown in a parked position, 135-degree rotation and 180-degree rotation.

The extension member 23 can be coupled to a second gear 52 wherein the second gear can be removably coupled to at least one of the first moveable member 31 or second moveable member 32. The second gear 52, as shown in FIG. 5, can comprise a second gear housing 79 that fully or partially houses at least one linear gear 80 coupled to a gear set wherein the gear set can be such as, for example, 2:1, 3:1, 4:1 or the like providing a mechanical advantage that allows for the easy adjustment of the position of the second movable member. The linear gear 80 can be coupled to a gear hub machined for tabs 86 and coupled to at least one alignment pin 84. The second gear 52 can have at least one roller pin 89 and a pivot pin 88 wherein the extension member 23 can rotate about the pivot pin. The second gear 52 can be coupled to the second movable member 32, providing a means of adjusting the position of the second movable member relative to the extension member 23. An exemplary embodiment of the second gear 52 is as shown in FIG. 8.

The main member 12 of the stationary section 11 can be coupled to at least one support member 26. The support member 26 can be rotatably or pivotably coupled to the main member 12 by a support joint 25, allowing for the rotation of the support member relative to the main member. The support member 26 can form such as, for example, an A-frame, or the like with each side of the A-frame being coupled to at least one caster 28. The support member 26 and the casters 28 can support the truck bed mounted carrier system 10 when the user pulls out of the truck bed, providing a stable and secure platform for the transportation of items.

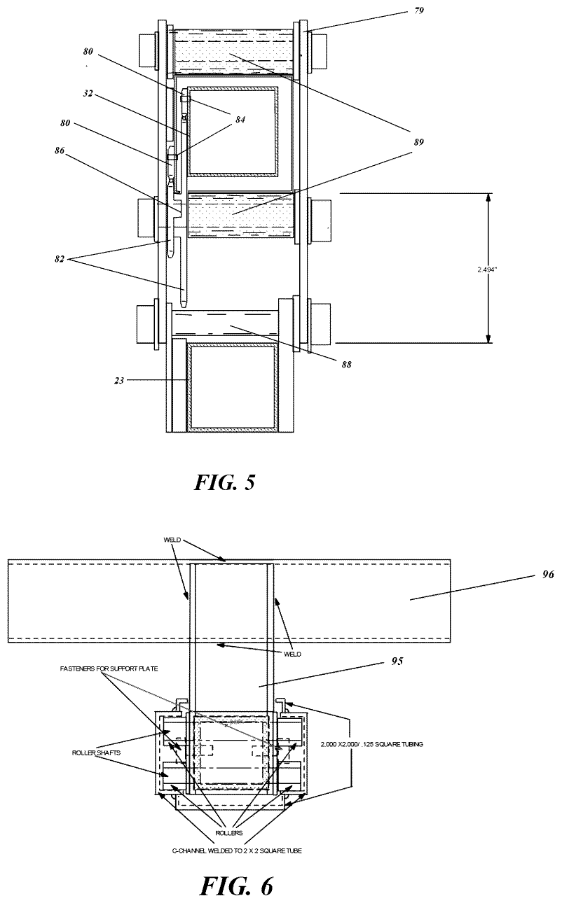

The first carrier adapter 40 and second carrier adapter 41, as shown in FIG. 6, can comprise a vertical bar 95 and a horizontal bar 96 wherein the horizontal bar and vertical bar can be coupled together by such as, for example, weld, fastener, rivets, adhesive or the like. The vertical bar 95 can be removable or permanently coupled to the third movable member 34 and/or the first movable member 31.

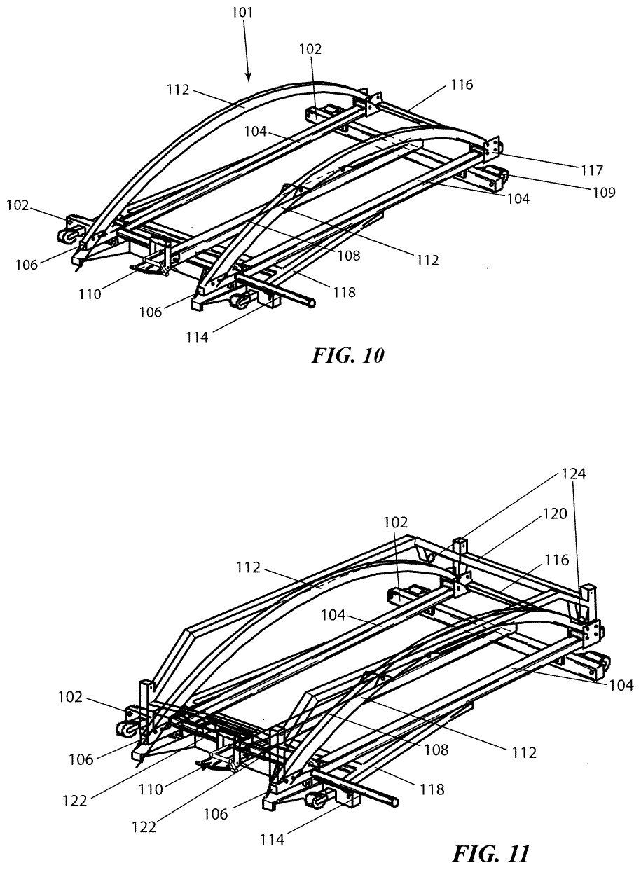

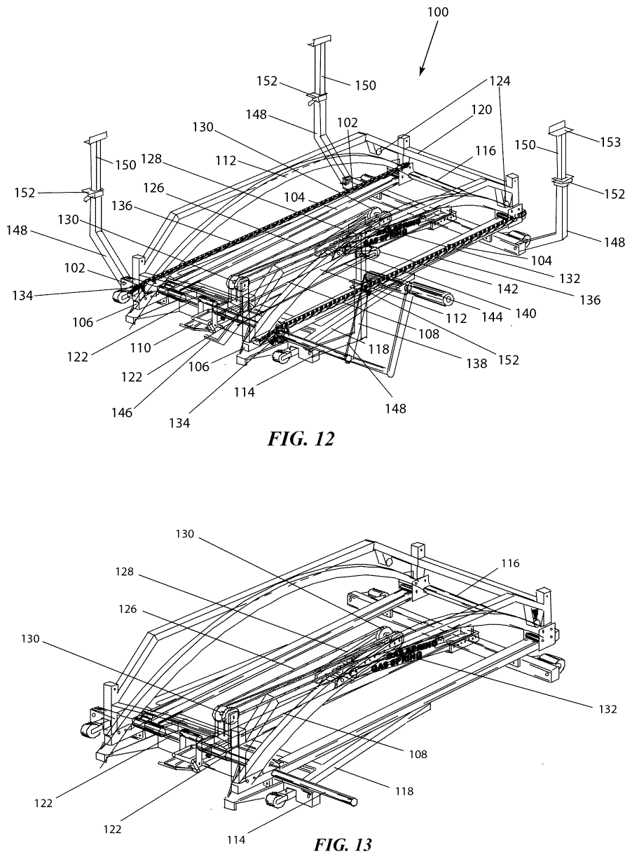

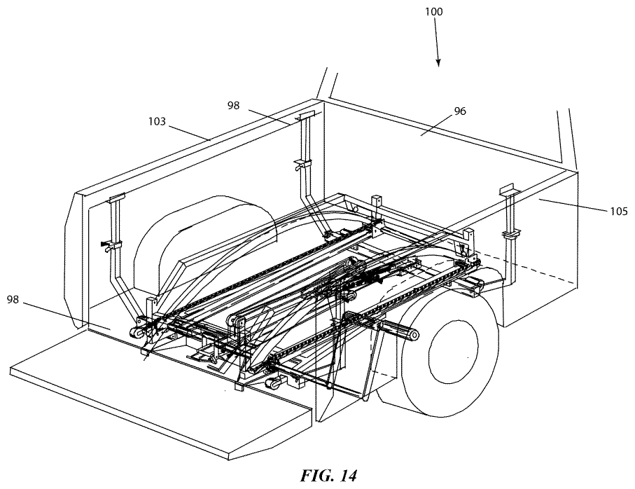

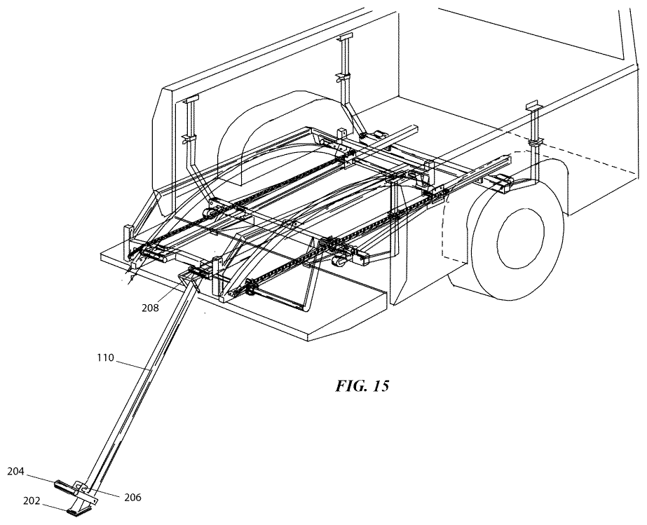

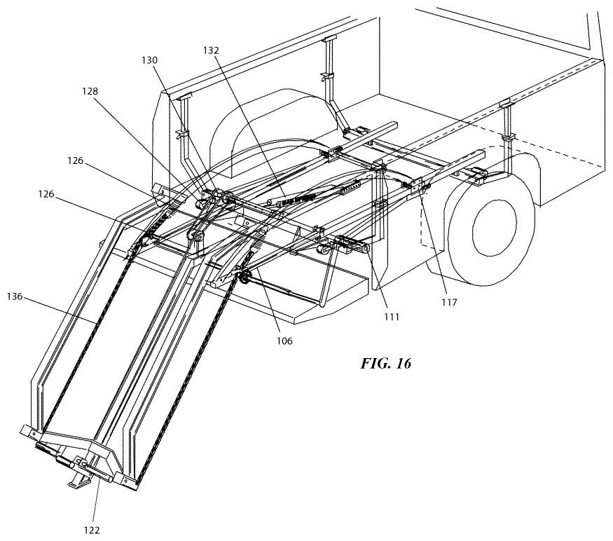

Referring to FIGS. 10-15 shows a truck bed mounted carrier system shown generally at 100 wherein the truck bed mounted carrier system which can be coupled to a bed and a railing 92 of a truck 94 wherein the truck can have a forward end 96 and an aft end 98 and a first side 103 and a second side 105, as shown in FIG. 13. The truck bed mounted carrier system 100 can comprise a frame assembly 101 having at least one lateral support 102 coupled to at least one outer main support 104. In the preferred embodiment, the at least one lateral support can be on the first side 103 and the at least one lateral support can be on the second side 105. The at least one outer main support outer 104 can be on the forward end 96 of the truck and the at least one outer main support 104 can be on the aft end 98 of the truck. The at least one lateral support 102 and the at least one main support 104 can be coupled together by such as, for example, fasteners, welded, rivets or the like. The at least one lateral support 102 and the at least one main support 104 can be such as, for example, tube, round stock, square stock, I-beam, channel, angle, or the like. The later support 102 can further comprise at least one wheel 109 which can be located on all four corners of the frame for allowing the user to easily place the truck bed mounted carrier system 100 into the bed of the truck.

In embodiments, the frame assembly 101 can further comprise inner supports 106 wherein the inner supports can slidably move within the outer main support wherein the inner supports can have a comprise a shaft bushing 236. The inner supports 106 can be such as, for example, tube, round stock, square stock, I-beam, channel, angle, or the like. The inner supports 106 can smoothly slide within the outer main supports 104 and in certain embodiments can be coated with such as, for example, Delrin, PTFE, nylon, ultra-high-molecular-weight polyethylene (UHMW), or other low-friction materials to reduce wear and facilitate smooth telescoping movement between the components.

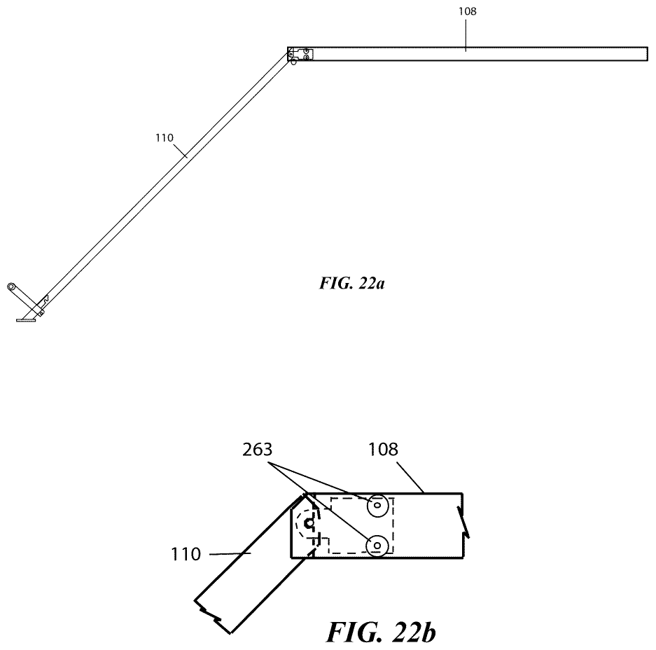

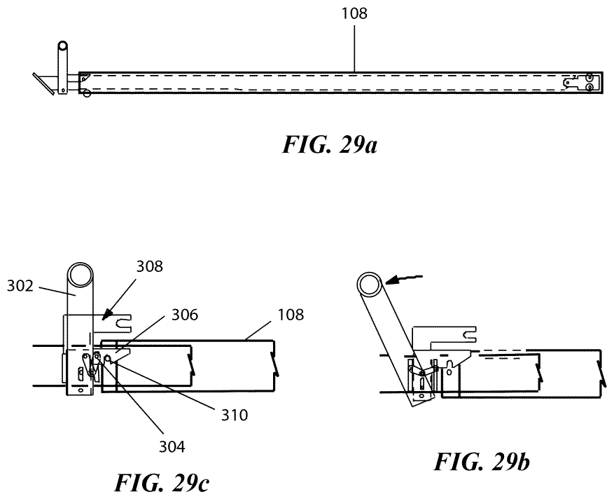

The frame assembly 101 can further comprise a center outer support 108 can be structurally coupled to the at least one lateral support 102 at the forward end 96 and at the aft end 98 using high-strength mechanical fasteners, welded joints, or precision-machined interlocking features. The center outer support 108 can be slidably coupled to a second inner support 110 wherein the second inner support can extend outwardly from the center outer support in a controlled and adjustable manner, allowing for variable positioning capabilities during operation wherein the second inner support can have a handle 204 and a storage hook 206 coupled to its aft end wherein the storage hook can be detachably coupled to storage hooks shaft 208 when in its fully collapsed position. The second inner support 110 can have inner roller bearings 263 which can be coupled to the forward end of the inner support allowing the second inner support to easily move within the center outer support as shown in FIG. 22a and FIG. 22b. The inner support 110 can have an inner support release 110 wherein the inner support release can have an inner support lever 302 coupled to at least one release pivot 304 and coupled to a rotational locking plate 306 which can be removably coupled to a lock pin 310 that can be pressed into the center outer support 108 wherein the locking plate can keep the inner support within the outer support when in its closed position or released when its extended position as shown in FIG. 29a-FIG. 29c. The inner support lever 302 can be coupled to a pin plate 308 which can be removably coupled to carrier frame 120.

The center outer support 108 and the second inner support 110 can be manufactured from such as, for example, tube, round stock, square stock, I-beam, channel, angle, carbon fiber composites, titanium alloys, aircraft-grade aluminum, or other engineered materials selected for their optimal strength-to-weight ratio and resistance to environmental degradation. These components can be further reinforced at critical stress points and may incorporate internal stiffening elements to prevent deflection under dynamic loading conditions. The interface between the center outer support 108 and second inner support 110 can include precision-machined bearing surfaces, self-lubricating bushings, or integrated roller systems to maintain smooth operation throughout the complete range of extension.

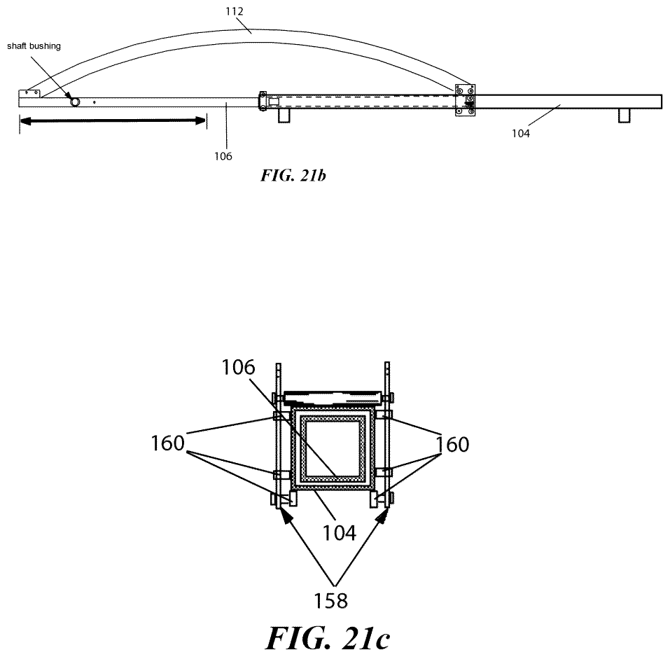

At least one radius support 112 can be positioned on the first side 103 and the at least one radius support can be symmetrically arranged on the second side 105, with each radius support coupled to a first slide 117 on the forward end 96 and securely attached to the inner support 106 on the aft end 98 by such as, for example, high-tensile fasteners, structural-grade welding, aircraft-specification rivets, or other advanced joining methodologies that maintain structural integrity under dynamic loading conditions wherein the mechanical connection points are strategically reinforced to distribute stresses evenly and prevent localized fatigue during extended operational cycles. The at least one radius support 112 and inner support 106 can be in a closed position and can extend outwardly from the outer main support 104 as shown in FIGS. 21a and 21b. A second lateral support 116 can be coupled to the first 117 adding structural support between both first slide's on first side 103 and the second side wherein the second lateral support can be such as, for example, tube, round stock, square stock, I-beam, channel, angle, carbon fiber composites, titanium alloys, aircraft-grade aluminum, or the like.

The at least one radius support 112 can be fabricated from such as, for example, tube, round stock, square stock, I-beam, channel, angle, carbon fiber composites, titanium alloys, aircraft-grade aluminum, or other engineered materials selected for their optimal strength-to-weight ratio and resistance to environmental degradation. These components may undergo specialized heat treatments, anodization, or protective coatings to enhance corrosion resistance and maintain structural properties when exposed to harsh operational environments. The material selection and dimensional specifications can be customized based on anticipated loading requirements, weight constraints, and service life expectations.

The at least one radius support 112 can be formed into a radius shape as shown in FIG. 10, with the curvature precisely calculated to optimize load distribution while maintaining minimal material usage. The radius geometry provides resistance to torsional and bending forces compared to linear supports of equivalent mass, significantly enhancing the overall structural efficiency of the assembly. The radius profile may incorporate variable wall thicknesses with reinforcement at high-stress regions to further optimize the strength-to-weight characteristics. The first slide 117 can incorporate such as, for example, sealed precision roller bearings, self-aligning ball bearings, needle bearings, or linear motion bearings housed within a high-strength carriage assembly. These bearing systems enable smooth, low-friction movement while maintaining precise positional control throughout the operational range. The bearing races and rolling elements can be manufactured from hardened stainless steel, ceramic composites, or other wear-resistant materials to ensure extended service life under continuous operation. The first slide 117 can further include integrated dust seals, wipers, and lubricant reservoirs to maintain optimal performance in contaminated environments, while also featuring adjustable preload mechanisms to eliminate unwanted play or deflection under varying load conditions.

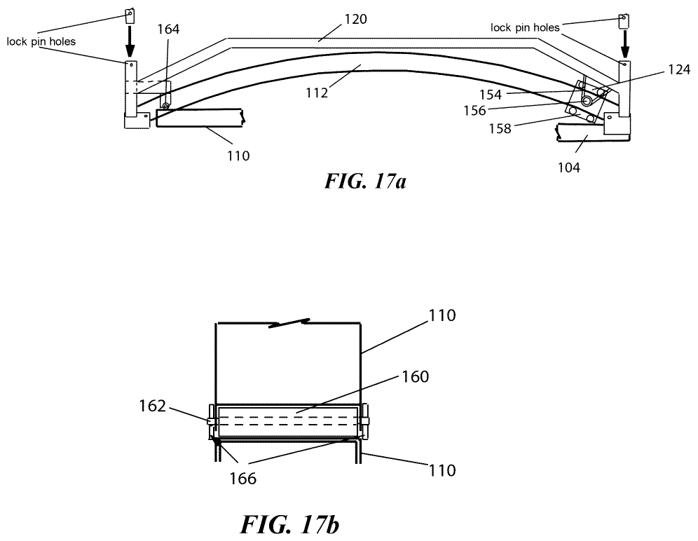

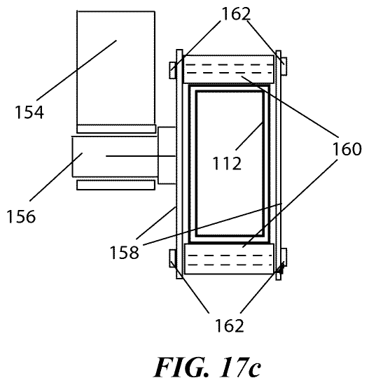

Referring to FIG. 17, a carrier frame 120, which can be any suitable shape or size and in the preferred embodiment exhibits the configuration as shown in FIGS. 11 and 17, can be positioned on the first side 103 and the second side 105. The carrier frame 120 can be coupled to a second slide 121 on the forward end 96, wherein the second slide incorporates a bearing support 124. This bearing support assembly comprises an integrated system of components including at least one of a bushing bracket 154, a pivot shaft 156, at least one roller 160 with sealed bearings, and at least one bushing plate 158. The at least one roller 160 can be rotationally coupled to the bushing plates by a bushing shaft 162, wherein the rollers can be implemented as ball bearings, tapered roller bearings, needle bearings, or similar rotational elements, which collectively enable the carrier frame 120 to traverse smoothly along the radiused supports 112 with minimal friction and operational noise. The bearing assemblies can include sealing systems to prevent contamination from environmental debris and lubrication reservoirs for extended operation. The carrier frame 120 can have at least one carrier handles 122 on the aft side of the from allowing the user to pull out on the carrier frame. The at least one carrier handles 122 can have such as, for example, a protective coating, knurled grip, neoprene, foam or the like allowing the user to easily grip the carrier handle.

The carrier frame 120 can be constructed from such as, for example, tube, round stock, square stock, I-beam, channel, angle, carbon fiber composites, titanium alloys, aircraft-grade aluminum, or other materials selected for their strength-to-weight ratio and resistance to environmental degradation and can be such as, for example welded, fastened, brazed, plasma welded, or the like together to frame the complete body of the carrier frame. The frame components can undergo additional treatments such as shot peening to enhance fatigue resistance, coatings for corrosion protection, or reinforcement at high-stress junctions. The structural design distributes loads effectively while minimizing overall mass. The carrier frame 120 can have locking pin holes 160 on each of its corners, which are machined to accept standardized accessory mounts, thereby enabling a user to securely attach purpose-specific accessories for transporting various items such as, for example, boats, kayaks, paddle boards, bicycles, cargo containers, ladders, lumber, construction materials, or similar recreational and professional equipment in the bed of the truck. These mounting points incorporate reinforced bushings and may include threaded inserts to maintain thread integrity during repeated accessory changes.

The carrier frame 120 can further be enhanced through its coupling to at least one third slide 164 on the forward end 98, wherein the third slide can be positioned on both the first side 103 and the second side 105 to ensure balanced load distribution and smooth operational characteristics. The at least one third slide 164 comprises a roller 160 assembly that traverses on the top side of the inner support 110 as the carrier frame 120 extends out of the truck bed, providing additional stability and load-bearing capacity during deployment operations. The roller 160 can be rotatably coupled to the at least one slide 164 through a retention system utilizing a self-locking pin 166, a bearing shaft 162, or any other established methodology that securely anchors the roller assembly while simultaneously allowing unrestricted rotational movement on the supporting surface. These roller assemblies may incorporate polymer compounds or hybrid bearing technologies to minimize rolling resistance while maximizing durability under repeated loading cycles.

The entire slide system is designed with consideration for thermal expansion, load deflection, and operational clearances to maintain functionality across varying environmental conditions. Motion components may feature adjustable mechanisms to eliminate unwanted play while preventing binding during extension and retraction operations. The system is designed to maintain consistent motion throughout the full range of travel, ensuring controlled deployment regardless of loading conditions or orientation.

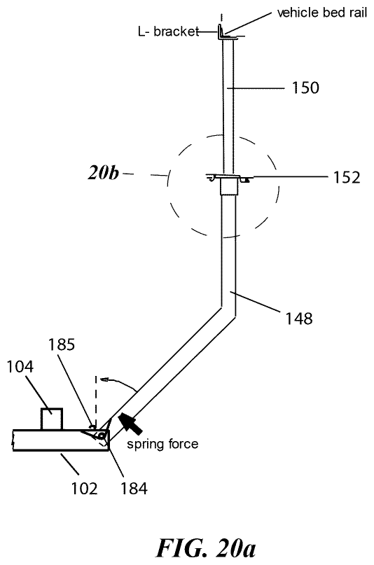

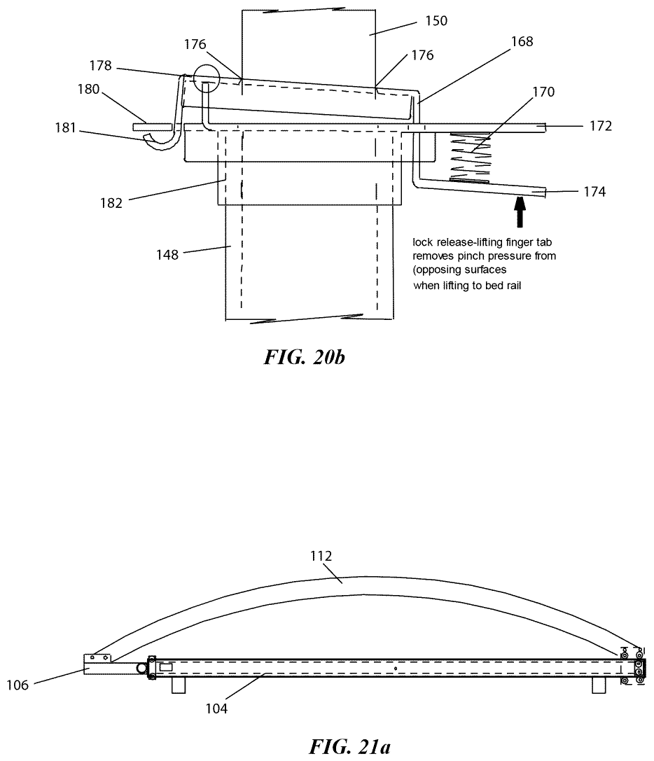

Referring back to FIGS. 10-15, the at least one lateral support 102 can have a lower bed rail strut 148 adjustably coupled to it, creating a robust foundation for the entire mounting system. The lower bed rail strut 148 can have multiple adjustment points to accommodate varying truck bed dimensions and configurations. The lower bed strut 148 can be manufactured from high-strength materials such as steel tubing, extruded aluminum, or composite materials depending on the anticipated load requirements and environmental exposure conditions. The lower bed rail strut 148 can have an upper bed rail strut 150 adjustably coupled to it through a telescoping arrangement, which enables precise height adjustment to match specific truck bed geometries. The coupling mechanism can utilize various attachment methods including bolted connections with lock washers, pinned joints, or welded assemblies depending on whether permanent or temporary installation is desired. The interface between these components can be reinforced using gusset plates, doubling plates, or structural adhesives to enhance load distribution and minimize stress concentrations. The lower bed rail strut 148 can be any suitable shape and size and in preferred embodiment the lower bed rail strut can be angled as shown in FIG. 20a. The lower bed rail strut 148 can be rotatably coupled to the lateral support 102 at a joint with a torsion spring 184 pressing against the lower bed rail strut keeping it in an open position, closed position, or partially open position wherein a tube stop 185 can stop the lower bed rail strut from opening past a point, wherein the lower bed rail strut can be in a closed position

The lower bed rail strut 148 and the upper bed rail strut 150 assembly incorporates an inner support tube lock 152 which functions to securely lock the upper bed rail strut in the lower bed rail strut, preventing unwanted movement during operation wherein the locking mechanism can be implemented using various designs such as spring-loaded pins, cam-lock fasteners, threaded compression devices, or quick-release clamps that allow for rapid adjustment while maintaining secure positioning once set. The locking components can be manufactured from corrosion-resistant materials such as stainless steel, brass, or engineered polymers to maintain functionality in exposed environments.

The lower bed rail strut 148, the upper bed rail strut 150 and inner support tube lock 152 configuration can be strategically replicated at all four corners of the truck bed mounted carrier system 100, creating a symmetrical support structure that distributes loads evenly throughout the truck bed and prevents distortion or binding during operation. Each corner assembly can be individually adjusted to accommodate uneven surfaces or manufacturing variations in the truck bed, ensuring proper alignment of the carrier system components. The upper bed rail strut 150 features an attachment member 153 at its upper terminus, wherein the attachment member can be such as, for example, angle iron with appropriate gusset reinforcement, U-channel with multiple mounting points, L-brackets with slotted adjustment capabilities, custom-formed sheet metal brackets, or similar structural profiles wherein the attachment members can be joined using various welding processes including MIG welding for general structural connections, TIG welding for precision joints requiring minimal distortion, or resistance spot welding for sheet metal components. In applications requiring dissimilar material joining, specialized techniques such as friction stir welding, adhesive bonding combined with mechanical fasteners, or brazed connections may be employed.

The attachment member 153 can be removably coupled to the inside upper panel 98 of the truck bed using various fastening methods such as carriage bolts with backing plates, through-bolts with reinforced washers, self-tapping structural screws, or specialized clamping mechanisms that do not require permanent modification of the truck bed wherein this connection technique can keep the truck bed mounted carrier system 100 securely fastened within the truck bed while allowing for removal when full bed capacity is required. The attachment member 153 can incorporate vibration-dampening elements such as lock washers, thread-locking compounds, or elastomeric bushings to prevent loosening during extended operational periods. The entire rail strut assembly can be surface-treated using various finishing processes such as powder coating, galvanization, anodizing for aluminum components, or specialized protective coatings to enhance corrosion resistance and maintain aesthetic appearance throughout the service life of the system. Critical load-bearing interfaces may receive additional surface treatments such as nitriding, carburizing, or hard-chrome plating to enhance wear resistance in high-stress contact areas.

Referring to FIGS. 20a-20b, in certain embodiments, the inner support tube lock 152 can comprise a base plate 180, a base plate support 182, and a pinch plate 168, creating an integrated locking mechanism that secures the telescoping components in position during operation. The base plate 180 can have at least two machined slots that allow the pinch plate to be partially inserted into the base plate, creating a guided pathway for controlled movement during engagement and disengagement operations wherein the slots can be formed using various manufacturing methods including CNC machining, EDM cutting, laser cutting, or precision stamping depending on production volume requirements and material specifications. The base plate 180 can have a thumb tab 172 that provides a comfortable contact point for operator interaction while simultaneously serving as an anchor point. The thumb tab 174 can be contoured to match natural finger geometry and may incorporate textured surfaces or grip-enhancing features to improve tactile feedback during operation in adverse conditions including wet environments or when wearing work gloves.

The pinch plate 168 can have multiple functional elements such as a finger tab 174 positioned for convenient operator access and a precisely formed retaining tab 181 that limits travel within the base plate assembly. On the finger tab 174 side, a compression spring 170 can be positioned to exert continuous force against both the thumb tab and the finger tab, creating a reliable self-tensioning system that maintains consistent pinch point 176 pressure between the upper bed rail strut 150 and the pinch plate at a minimum of two contact points. The spring 170 can be manufactured from various materials including music wire, stainless steel, or chrome silicon depending on required spring rate and corrosion resistance requirements.

The base plate support 182 can be securely coupled to the lower bed rail strut 148 using multiple attachment methodologies such as, for example, structural adhesive bonding with proper surface preparation, various welding processes including MIG welding for general structural connections, TIG welding for precision components requiring minimal heat distortion, robot-assisted welding for production consistency, or mechanical interference fit created through precision machining or controlled deformation processes. In applications requiring dissimilar material joining, specialized techniques such as friction stir welding for aluminum components, adhesive bonding combined with mechanical fasteners, or brazed connections may be employed to create robust structural connections without compromising material properties. The base plate 180 can have a fulcrum 178 which can serve as a contact point for the pinch plate 168, creating a mechanical advantage through lever action that multiplies the operator's input force. This fulcrum point can be positioned to optimize the mechanical advantage of the system while ensuring adequate clamping force is generated at the pinch points. The geometry and surface profile of the fulcrum 178 can be tailored to minimize wear during repeated cycling operations and may incorporate hardened inserts in high-wear applications.

When the pinch plate 168 engages the upper bed rail strut 150, it creates at least one pinch point 168 that securely locks the components together through frictional engagement wherein the pinch points can be enhanced through the incorporation of specialized surface textures, hardened inserts, or elastomeric elements that increase frictional forces while minimizing surface damage to the mating components. The design ensures that vibration and operational loads cannot inadvertently disengage the locking mechanism during use. The finger tab 174 can be pressed by the operator to release the pinch points through a mechanical advantage system, allowing the upper bed rail strut 150 to move freely during height adjustment operations. The release action requires minimal effort due to the mechanical advantage provided by the lever system, enabling single-handed operation even when the system is under load. Upon release of the finger tab 174, the compression spring automatically returns the locking mechanism to its engaged position once the desired adjustment has been completed, ensuring that the system remains securely locked without requiring additional operator action.

The entire locking assembly can be manufactured using corrosion-resistant materials such as stainless steel, aluminum alloys, or engineered polymers depending on strength requirements and environmental exposure conditions. Critical wear surfaces may receive additional surface treatments such as nitriding, carburizing, or specialized coatings to enhance durability throughout the service life of the system. The assembly can be designed for maintenance-free operation or may incorporate lubrication ports to allow periodic service in extreme operating environments.

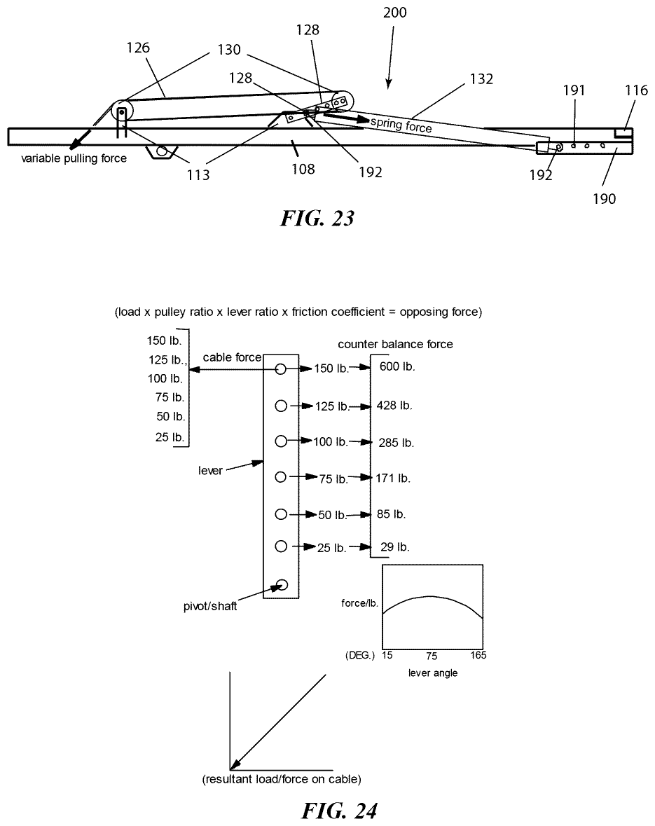

Referring to FIGS. 10-15, 18a, 18b and 23, truck bed mounted carrier system 100 can further comprise a pulley assist 200 which functions as a load-balancing mechanism to reduce operator effort during deployment and retraction operations. The pulley assist can comprise at least one pulley support bracket 113 that can be coupled to the center outer support 108 in at least two strategic locations to distribute operational forces effectively across the structure. These support brackets can be fabricated from formed sheet metal, cast components, machined plates, or extruded profiles with additional reinforcement at high-stress areas. The mounting interface can incorporate multiple fastening points to prevent rotation or displacement under dynamic loading conditions.

At least one variable spring end position plate 190 can be coupled to the forward end of the center outer support 108 by such as, for example, continuous or stitch welding processes including MIG, TIG, or resistance welding, structural adhesives with appropriate surface preparation and curing protocols, mechanical fasteners with torque specifications and locking features, or combination attachment methods that provide redundancy in critical loading situations. The position plate can be designed with multiple adjustment positions to allow for field tuning of the system based on varying load requirements and user preferences. The at least one variable spring end position plate 190 can have at least one positioning hole 191 through it which can allow the aft end of at least one gas spring 132 to be rotatably coupled to it using a clevis mount, rod end bearing, or spherical joint assembly. These mounting holes can be precision machined, flame cut or formed depending on material thickness and production requirements. The hole pattern can be designed to allow for adjustment of spring preload, operating angle, or mechanical advantage based on the specific application requirements. The at least one gas spring 132 can have an extension force of such as, for example, 50 lbs. to 600 lbs., and more preferably 100 lbs. to 400 lbs. and still more preferably 300 each wherein in the preferred embodiment two gas springs can have an extension force of 600 lbs.

The forward end of the at least one gas spring 132 can be rotatably coupled to at least one variable position lever 128 through a bushing 192 wherein the shaft can be such as, for example, shaft, pivot pin, rod, bronze flanged bushing with lubrication groove, self-lubricating polymer composite bushing, needle roller bearing assembly, thrust bearing for side loading applications, or similar low-friction rotational component. The attachment design can accommodate some misalignment without binding, ensuring smooth operation throughout the full range of motion. A cable 126, which can be constructed from aircraft-grade stainless steel wire rope with appropriate diameter and construction for the anticipated loading conditions, synthetic fiber rope with UV and abrasion resistance, or coated steel cable with corrosion protection, can be rotatably coupled to at least one pulley 130. The cable terminations can utilize swaged fittings, crimped connections, or mechanical clamps designed to achieve the full strength of the cable without creating stress concentration points.

In the preferred embodiment, the at least one pulley 130 can be coupled to the opposing end of the variable position spring lever 128 that the at least one gas spring 132 can be coupled to by a bushing 192, creating a balanced moment arm for optimal force distribution. Additionally, another pulley 130 can be coupled to the pulley support bracket 113 that can be coupled to the center outer support 108 on the aft end of the system 100 by a bushing 192, creating a mechanical advantage system that effectively multiplies the counterbalance force. These pulleys 130 can incorporate sealed ball bearings to minimize maintenance requirements, bronze bushings for high-load applications, or composite bearings for corrosion resistance in marine environments. The pulley 130 diameter can be optimized to balance cable bend radius requirements with package space constraints.

The pulley assist 200 creates a counter balance force within the system as shown in FIG. 24, which significantly reduces the effort required by the operator during extension and retraction operations. This counter-balancing effect compensates for the weight of the carrier frame 120 and transported items through mechanical advantage principles, making the system usable by operators with varying physical capabilities without requiring powered assistance. The force profile can be tuned to provide increasing assistance as the carrier extends further from the truck bed, when the mechanical disadvantage would otherwise be greatest. The cable 126 can be coupled to the aft end of the inner support tubes 106, wherein the aft end of the inner support tube can have a rotatable foot 202 that can rotate and come into contact with the ground or fold up when positioned in the bed of the truck. This foot 202 can incorporate wear-resistant materials at ground contact points such as hardened steel, polymer composites, or replaceable wear plates and may feature non-slip texturing or patterns to enhance stability on varied surfaces during loading and unloading operations.

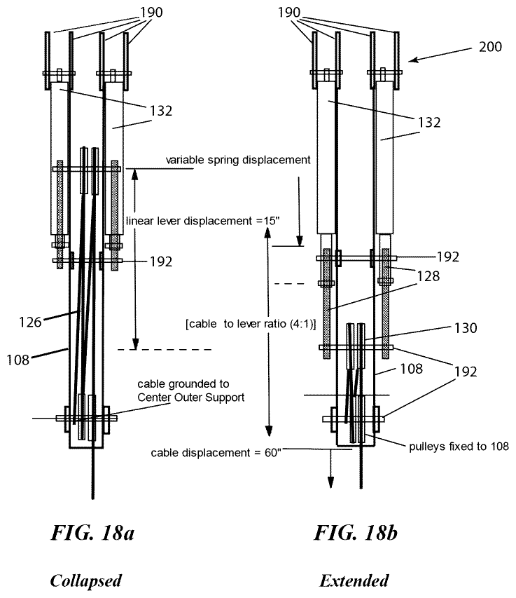

The pulley assist 200 can be in a collapsed position, as shown in FIG. 18a when the system is fully retracted within the truck bed, or in an extended position as shown in FIG. 18b when the user operates the truck bed mounted carrier system 100. The transition between these positions occurs seamlessly during normal operation through the mechanical linkages without requiring additional operator input. The linear lever displacement, variable spring displacement, and cable displacement can be such as, for example, at least 5 inches to 100 inches and even more preferably 10 inches to 80 inches and still more preferably 15 inches to 60 inches. The cable to lever ratio can be such as, for example, 2:1, 3:1, 4:1, 5:1 or the like.

The system can incorporate damping elements within the gas spring 132 design to prevent sudden movements during extension and retraction and may include mechanical stops to prevent over-extension or over-compression in extreme operating conditions. The entire pulley assist 200 can be designed for all-weather operation with consideration for thermal expansion, moisture exposure, and contaminant intrusion. Critical components such as pulleys 130, cables 126, and pivot points may receive additional protection through material selection, protective coatings, sealed designs, or sacrificial elements in corrosive environments. The pulley assist 200 can be designed to operate effectively across a wide temperature range with appropriate material selection and clearances to accommodate thermal expansion and contraction. Maintenance considerations can be addressed through access ports, removable covers, or strategic component placement that allows for periodic inspection and service of wear components without requiring complete disassembly of the system. Lubrication points can be consolidated where possible and designed for compatibility with common maintenance tools and practices, enhancing the long-term reliability and user satisfaction with the truck bed mounted carrier system. In certain embodiments, the pully assist 200 can be replaced with such as, for example, a winch system, come-alongs, block and tackle or the like.

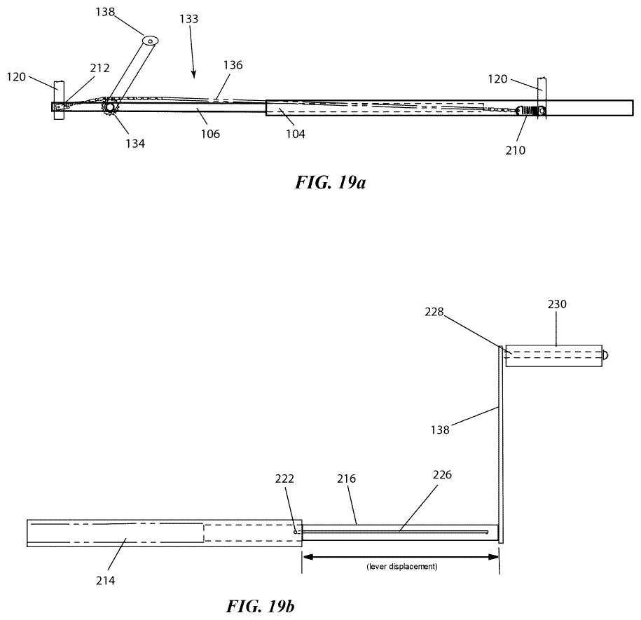

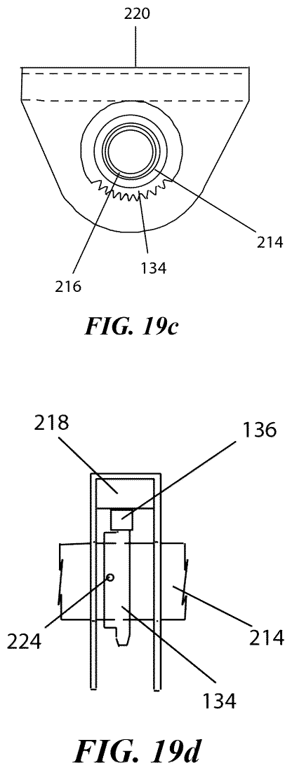

Referring to FIGS. 10-15 and 19a-19c, the truck bed mounted carrier system 100 can further comprise mechanical drive assembly 133 comprising a sprocket 134 coupled to a handle 138, creating a mechanical advantage system that facilitates smooth extension and retraction operations. The sprocket can be precision-machined from hardened steel, sintered metal, or high-strength polymer composite to provide durability while minimizing weight and production costs. The tooth profile can be optimized for engagement with the roller chain while minimizing backlash and wear during operation. The sprocket 134 can be rotatably coupled to a roller chain 136 through a positive engagement drive system wherein the roller chain is coupled to an extension spring 210 on its forward end and the carrier frame 120 on its aft end by a pivot link 212, as shown in FIG. 19a. This arrangement creates a flexible power transmission system that accommodates the changing geometry during extension and retraction cycles. The roller chain can be manufactured to industry standards such as ANSI, ISO, or DIN specifications with appropriate pitch and width dimensions based on load requirements. The chain can incorporate hardened pins and rollers to enhance durability in exposed environments and may feature specialized coatings or materials for corrosion resistance in marine applications.

The extension spring 210 provides tension management throughout the operational range, ensuring consistent chain engagement with the sprocket while accommodating the varying distance requirements during extension and retraction. The extension spring 210 can be sized with appropriate spring rate, free length, and maximum extension parameters to maintain optimal tension without overloading components. The extension spring 210 material can be selected from various options including music wire, stainless steel, or chrome silicon based on environmental exposure conditions and loading requirements.

The pivot link 212 can create a flexible connection between the roller chain 136 and carrier frame 120, allowing for angular displacement during operation while maintaining a secure attachment point. This pivot can incorporate bushings, bearings, or self-lubricating elements to ensure smooth rotation throughout the service life of the system. The pivot geometry can be designed to distribute loads evenly and eliminate stress concentrations that could lead to premature failure. The sprocket 134 can have an outer rotational drive tube 214 and an inner rotational drive tube 216 arranged in a telescoping configuration, partially housed in a channel guide 220 that provides structural support and maintains proper alignment during operation. The channel guide 220 can be formed from sheet metal, extruded aluminum, or structural composites with appropriate reinforcement at mounting points. The channel design can incorporate drainage features to prevent water accumulation in outdoor applications.

The channel guide 220 can have a rub plate 218 that can be such as, for example, ultra-high-molecular-weight polyethylene (UHMW), nylon, acetal homopolymer (Delrin), polytetrafluoroethylene (PTFE), or similar low-friction material which can guide the roller chain 136 and keep it aligned on the sprocket 134 throughout the operating range. This rub plate 218 reduces friction and wear while providing lateral support to prevent chain derailment during operation. The rub plate 218 can be designed for replacement during service intervals without requiring disassembly of the primary structure. The sprocket 134 can have a set screw 224 with appropriate thread-locking features to position the handle 138 in the desired position for optimal leverage based on operator preferences and loading conditions. The set screw 224 can incorporate a tamper-resistant design in public applications or include positive locking features to prevent loosening due to vibration during transport. The interface between the sprocket and drive tube can include splines, keyways, or knurled surfaces to prevent rotation under load.

The outer rotational drive tube 214 can be coupled to the inner rotational drive tube 216 by a slot pin 222 which creates an adjustable connection while maintaining rotational synchronization between the components. The inner tube can have a longitudinal slot 226 for adjusting the inner rotational drive tube in and out of the outer rotational drive tube, allowing customization of the handle position based on operator preference or truck bed configuration. The slot pin 222 can slide within the longitudinal slot and be secured with a threaded fastener, cam-lock mechanism, or quick-release pin, stabilizing the inner rotational drive tube in the selected position. This adjustment feature accommodates operators of varying heights and reach capabilities.

The inner rotational drive tube 216 can have handle 138 coupled to it and extending from it to a handle shaft 228 which can be rotatably coupled to a lever handler 230, creating an ergonomic interface for the operator. The lever handle 230 can incorporate contoured grips, textured surfaces, or elastomeric overmolding to enhance comfort during operation. The rotational coupling can utilize bearings, bushings, or self-lubricating elements to ensure smooth operation throughout the service life. The lever to gear rotation ratio can be 1:1 in the standard configuration, providing direct positional control during operation, while the lever to gear force ratio can be 5:1, creating substantial mechanical advantage that reduces operator effort during extension and retraction operations. In alternative embodiments, this ratio can be modified to 2:1, 3:1, 4:1, 1:2, or other configurations based on specific application requirements, loading conditions, or user preferences. Higher ratios provide increased mechanical advantage at the expense of increased handle travel, while lower ratios reduce handle movement but require greater operator input force.

The entire drive mechanism can be designed for all-weather operation with appropriate seals, drainage features, and material selections to ensure reliability in exposed environments. The system can incorporate corrosion-resistant fasteners, protective coatings, or sacrificial elements in marine applications. Critical wear surfaces may receive additional hardening treatments or specialized coatings to extend service life, while maintenance points can be designed for accessibility during routine service intervals.

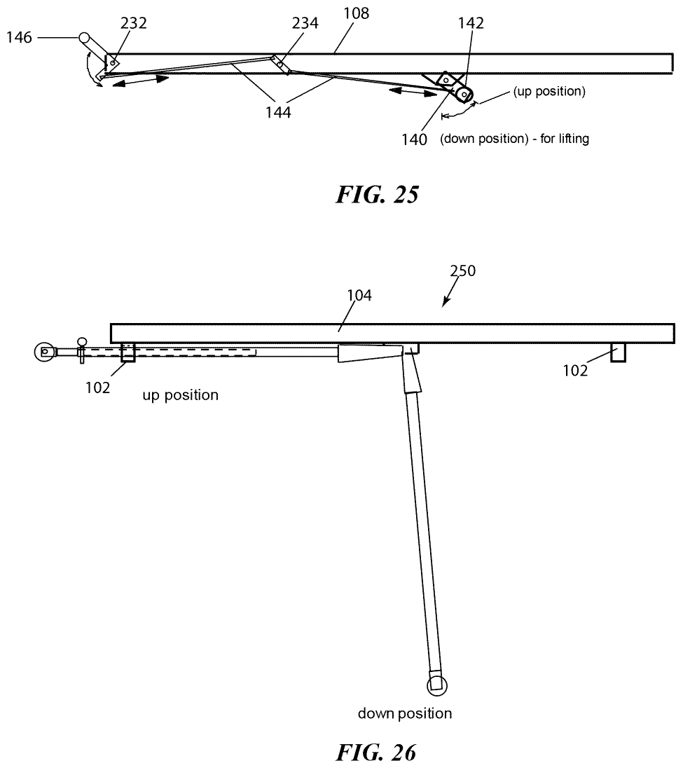

In embodiments, the truck bed mounted carrier system 100 can further comprise a roller lift lever 140, precision roller 142, a lever actuator rod 144, and an operator's lever 146, creating a mechanical advantage system for effortless repositioning of heavy loads. The operator's lever 146 can be coupled to the center outer support 108 by a rotational joint 232 that serves as the primary pivot point for the lifting operation as shown in FIG. 25. This rotational joint can incorporate bushings, bearings, or self-lubricating elements to ensure smooth operation and minimize maintenance requirements over the service life of the system. The joint can be designed with appropriate clearances to accommodate thermal expansion while preventing excessive play that could compromise positioning accuracy. The mounting hardware can include locking features to prevent loosening due to vibration during transport operations.

The operator's lever 146 can be coupled to the aft end of a bell crank 234 by an actuator rod 144 which transmits the operator's input force while accommodating the changing geometry during the lifting cycle. This actuator rod can be manufactured from high-strength materials such as alloy steel, chromoly tubing, or aircraft-grade aluminum depending on loading requirements and weight considerations. The rod ends can incorporate spherical bearings, rod end bearings, or bushed connections to accommodate misalignment during operation without binding or creating wear points.

On the front side of the bell crank 234, a second actuator rod can couple the bell crank to a roller lift lever 140, creating a multi-stage mechanical advantage system that multiplies the operator's input force. The bell crank 234 can serve as a force redirection component, changing the line of action while maintaining mechanical advantage through the system. The bell crank 234 can be designed with appropriate moment arms to optimize the force multiplication ratio while considering packaging constraints. The pivot point of the bell crank 234 can incorporate bushings or bearings sized for the anticipated loading conditions and service intervals.

The roller lift lever 140 has a roller 142 rotationally coupled to it by a bushing assembly that allows free rotation of the roller while maintaining positional control. The bushing can be selected from various materials including bronze, oil-impregnated sintered metal, or engineering polymers based on loading requirements and environmental exposure conditions. The roller 142 can be manufactured from hardened steel, polymer composites, or specialized materials with consideration for the contact surface to prevent damage during lifting operations. The roller lift lever 140 can be rotationally coupled to and positioned substantially near the forward end of the center outer support 108, creating an optimal leverage point for lifting operations. This mounting location maximizes the mechanical advantage while minimizing the package space requirements of the system. The mounting hardware can include provisions for adjustment to accommodate manufacturing tolerances or to optimize performance based on specific loading conditions.

As the operator's lever 146 is pulled, it activates the entire linkage assembly, rotating the roller 142 into an up position or down position for lifting operations. The geometry of the linkage system can be optimized to provide increasing mechanical advantage as the load is lifted, counteracting the increasing moment arm of the load during the lifting cycle. The system can incorporate over-center locking features, detents, or locking mechanisms to maintain position once the desired height is achieved without requiring continuous operator input.

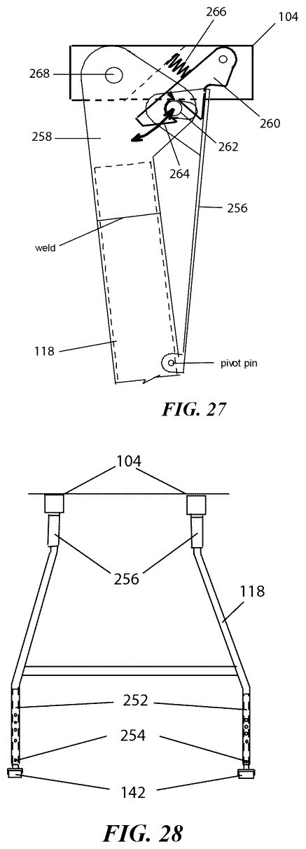

Referring to FIGS. 26-28, the truck bed mounted carrier system 100 can further comprise a support system 250 that provides stability during loading and unloading operations while maintaining a compact profile during transport. The support system 250 can have at least one transport stand 118 which can be pivotally coupled to the outer main support 104 through a robust hinge mechanism that allows for smooth transition between operational positions. The support system can be automatically deployed into a down position when the carrier system is extended to provide ground contact and stability and can transition to an up position when the system is retracted for transport, creating a streamlined profile that minimizes interference with other vehicle operations. In the preferred embodiment, the transport stand 250 can be symmetrically positioned on both the first side and the second side as shown in FIG. 28, creating balanced support that prevents twisting or uneven loading during operation. This dual-stand configuration distributes ground contact forces across multiple points, enhancing stability on uneven terrain while preventing excessive point loading that could cause soil penetration or stand damage on soft surfaces.

The at least one transport stand 118 can be designed in any suitable shape and size based on loading requirements, ground clearance considerations, and aesthetic preferences. The stand 118 can feature a telescoping design wherein a stand inner tube 252 can be adjustable within the transport stand outer tube, allowing for height customization based on vehicle ride height, loading conditions, or terrain variations. This adjustability feature accommodates vehicles with varying suspension configurations, aftermarket modifications, or load-induced height changes. The stand inner tube 252 can be securely locked into the desired position by a stand locking pin 254 that passes through aligned holes in both the inner and outer tubes. This locking pin 254 can incorporate a positive retention feature such as a spring-loaded ball detent, cotter pin, or locking clip to prevent unintentional disengagement during operation. The pin 254 can be designed for operation with gloved hands and may incorporate a tethering system to prevent loss during adjustment operations.

The at least one transport stand 118 can be coupled to a tube flange 258 using various attachment methodologies such as, for example, continuous or stitch welding with appropriate fillet size and penetration, high-strength mechanical fasteners with lock washers or thread-locking compounds, structural adhesives with proper surface preparation, or combination attachment methods that provide redundancy in critical loading situations. The attachment method can be selected based on material compatibility, loading requirements, and production considerations. The tube flange 258 can be rotatably attached to the outer main support 104 through a pivot assembly that incorporates bushings, bearings, or self-lubricating elements to ensure smooth operation throughout the service life of the system. This rotational interface allows the support system to transition between operational and stowed positions while maintaining structural integrity under load.

The tube flange 258 can incorporate an integrated locking system that comprises a lock lever 260 pivotally attached to the outer main support 104 by a lock pivot pin 268, creating a secure locking mechanism that prevents unintentional movement during use. The lock pivot pin 268 can be sized appropriately for the anticipated loading conditions and may incorporate retention features to prevent migration during operation. The lock lever 260 can feature a precisely profiled lock pin ramp 264 that facilitates automatic engagement during deployment, and a slot for a lock pin 262 that creates positive mechanical retention when engaged. This geometry allows for self-alignment during the locking operation while preventing disengagement under load conditions. The ramp profile can be optimized to provide smooth engagement while maintaining secure locking once positioned. When the lock pin 268 is engaged with the slot, the support system is securely locked in place, preventing unintentional folding during loading operations. This positive mechanical engagement creates redundant safety protection beyond the weight-bearing forces that would normally keep the stand deployed. The locking interface can be designed with appropriate clearances to accommodate thermal expansion and contraction without compromising locking integrity.

The upper portion of the support system 250 can incorporate a tailgate bump plate 256 which serves both as a contact surface for the vehicle tailgate during stowage and as a structural component of the locking system. The tailgate bump plate can have the lock pin 262 strategically positioned such that when the tailgate bump plate 256 is engaged with the lock lever, the support system is securely locked in the open position. This design creates an automatic locking feature that engages through the natural deployment motion without requiring separate operator actions. The tailgate bump plate 256 can be coupled to the transport stand 118 by a stand pivot pin 270 that creates the primary rotation axis for deployment operations. This pivot pin 268 can be sized appropriately for loading conditions and may incorporate bushings or bearings to ensure smooth operation throughout the service life of the system. The pivot assembly can include provisions for lubrication or utilize maintenance-free components to reduce service requirements.

A lock compression spring 266 can be strategically positioned to exert continuous force against the lock lever 260, always keeping it biased toward the engaged position and creating a fail-safe locking system. This spring 266 can be selected with appropriate spring rate, free length, and material properties to maintain optimal locking force throughout the operational temperature range. The spring tension can be tuned to provide positive locking action while still allowing manual release when desired. The entire support system can be designed for all-weather operation with consideration for corrosion protection, thermal expansion, and contamination from road debris. Components can receive appropriate surface treatments, material selection, or protective coatings based on environmental exposure expectations. Ground contact surfaces may incorporate wear-resistant materials, replaceable wear pads, or textured patterns to enhance stability on varied surfaces.

Safety considerations can be addressed through visible deployment indicators, redundant locking features, or automatic engagement systems that prevent user error during operation. The support system can be integrated with the carrier extension mechanism to ensure proper deployment sequencing and prevent operation with improperly positioned supports. Load rating information can be clearly marked on the components to prevent overloading during operation.

The method of installing the truck bed mounted carrier system 100 in a truck bed 94 by positioning the frame assembly between the forward end 96 and aft end 98 of the truck. The system includes lateral supports 102 coupled to outer main supports 104, with inner supports 106 slidably housed within the outer main supports. A center outer support 108 connects the lateral supports, and a second inner support 110 is slidably coupled to the center outer support. The user adjusts the lower bed rail struts 148 coupled to the lateral supports 102 to match the truck bed dimensions. The upper bed rail struts 150 are then telescoped within the lower bed rail struts to the appropriate height and secured using the inner support tube locks 152. The attachment members 153 on the upper bed rail struts are coupled to the inside upper panel of the truck bed, securing the system without permanent modification to the vehicle. When properly installed, the carrier system can be locked in a retracted position within the truck bed during transport.

To use the system, the user first rotates the handle 138 coupled to the sprocket 134. This action engages the roller chain 136 and uses the mechanical advantage provided by the gear ratio (typically 5:1) to begin extending the carrier frame 120 from the truck bed. As the handle is rotated, the at least one inner support 106 slides outward from the at least one outer main support 104. The radius supports 112 coupled to the inner supports and the carrier frame provide structural integrity during extension. As the carrier frame 120 extends beyond the tailgate, the transport stands 118 automatically deploy from their stowed position to a ground-engaging position. The tailgate bump plate 256 engages with the lock lever 260, and the lock pin 262 secures the support system 250 in place. The lock compression spring 266 ensures the locking mechanism remains engaged during operation. With the transport stands providing ground support, the user can safely load cargo onto the carrier frame.

For optimal operation, users can adjust various components of the system. The pulley assist mechanism 200 can be fine-tuned by adjusting the variable spring end position plate 190 coupled to the gas springs 132. When the carrier frame extends, the pulley assist mechanism automatically activates, creating a counterbalance force through the interaction of the variable position lever 128, pulleys 130, and cable 126. This significantly reduces the effort required to extend and retract the carrier, especially when loaded with heavy items. Height adjustments can be made by actuating the operator's lever 146 coupled to the bell crank 234. Force is transmitted through the actuator rod 144 to the bell crank and then to the roller lift lever 140 via a second actuator rod. This action rotates the roller 142 between raised and lowered positions, adjusting the height of the carrier frame to facilitate easier loading and unloading operations.

For user comfort, the inner rotational drive tube 216 can be adjusted relative to the outer rotational drive tube 214 by sliding the slot pin 222 within the longitudinal slot 226. Once positioned for optimal leverage based on the user's height and reach, the slot pin is secured to lock the inner rotational drive tube at the desired extension length. The transport stands 118 can also be height-adjusted by telescoping the stand inner tube 252 within the stand outer tube and securing it at the desired height using the stand locking pin 254. This feature allows the system to accommodate various truck heights and terrain conditions.

The carrier frame 120 features locking pin holes 160 at each corner, enabling the attachment of purpose-specific accessories for securing various items such as boats, kayaks, paddle boards, bicycles, and other equipment. The user can easily install and remove these accessories as needed for different transportation requirements. After unloading cargo, the user retracts the carrier frame 120 back into the truck bed by rotating the handle 138 in the opposite direction. As the carrier frame retracts, the at least one inner support 106 slides inward into the at least one outer main support 104. The transport stands 118 automatically fold from their deployed position to their stowed position as the carrier frame retracts. When fully retracted, the carrier frame locks securely in position for transport, with the second inner support 110 engaging with the storage hook 206 at its fully collapsed position.

To ensure smooth operation over time, the sliding components, including the inner supports 106 and the second inner support 110, should be periodically inspected for wear on their low-friction coatings (such as Delrin, PTFE, nylon, or UHMW). The roller bearings 160 in the first slide 117, second slide 121, and third slide 164 should be checked for free movement and lubricated as needed. The pulley assist mechanism 200 should be inspected to verify proper tension in the cable 126 and functionality of the gas springs 132. All locking mechanisms, including the inner support tube locks 152 and the transport stand locking system, should be tested regularly to ensure secure engagement during operation.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. A truck bed mounted carrier system, comprising:
a frame assembly configurable to be installed in a truck bed, the frame assembly comprising at least one lateral support, at least one outer main support coupled to the at least one lateral support, at least one inner support slidably coupled to the at least one outer main support, a center outer support coupled to the at least one lateral support, and a second inner support slidably coupled to the center outer support;
a carrier frame coupled to the frame assembly, the carrier frame configured to extend from and retract into the truck bed; and
at least one radius support coupled to the at least one inner support and the carrier frame, wherein the at least one radius support is configured to provide structural support to the carrier frame when extended from the truck bed.

2. The truck bed mounted carrier system of claim 1, further comprising a pulley assist mechanism coupled to the frame assembly, the pulley assist mechanism comprising at least one pulley support bracket coupled to the center outer support;
at least one variable spring end position plate coupled to the center outer support;
at least one gas spring having a first end rotatably coupled to the at least one variable spring end position plate; at least one variable position lever coupled to a second end of the at least one gas spring; at least one pulley coupled to the at least one variable position lever; and
a cable rotatably coupled to the at least one pulley and to the at least one inner support, wherein the pulley assist mechanism is configured to create a counterbalance force during extension and retraction of the carrier frame.

3. The truck bed mounted carrier system of claim 1, further comprising a mechanical drive assembly comprising:
a sprocket;
a handle coupled to the sprocket;
a roller chain rotatably coupled to the sprocket; and
an extension spring coupled to the roller chain and the carrier frame, wherein rotation of the handle causes movement of the carrier frame between extended and retracted positions.

4. The truck bed mounted carrier system of claim 3, wherein the mechanical drive assembly further comprises:
an outer rotational drive tube coupled to the sprocket;
an inner rotational drive tube adjustably coupled to the outer rotational drive tube; and
a channel guide having a rub plate configured to guide the roller chain and maintain alignment with the sprocket.

5. The truck bed mounted carrier system of claim 4, wherein the inner rotational drive tube is coupled to the outer rotational drive tube by a slot pin, the inner rotational drive tube having a longitudinal slot for adjustably positioning the inner rotational drive tube relative to the outer rotational drive tube.

6. The truck bed mounted carrier system of claim 1, further comprising a lifting mechanism comprising:
an operator's lever rotatably coupled to the center outer support;
a bell crank;
a first actuator rod coupling the operator's lever to the bell crank;
a roller lift lever;
a second actuator rod coupling the bell crank to the roller lift lever; and
a roller rotatably coupled to the roller lift lever, wherein actuation of the operator's lever causes the roller to move between raised and lowered positions.

7. The truck bed mounted carrier system of claim 1, further comprising a support system comprising:
at least one transport stand pivotally coupled to the at least one outer main support;
a tube flange coupled to the at least one transport stand; and
a locking mechanism configured to secure the at least one transport stand in a deployed position, wherein the at least one transport stand is configured to provide ground support when the carrier frame is extended from the truck bed.

8. The truck bed mounted carrier system of claim 7, wherein the at least one transport stand comprises a telescoping assembly having a stand inner tube adjustably coupled to a stand outer tube and secured by a stand locking pin.

9. The truck bed mounted carrier system of claim 7, wherein the locking mechanism comprises: a lock lever pivotally attached to the at least one outer main support; a lock pin ramp formed on the lock lever; a lock pin configured to engage with the lock lever; and a lock compression spring biasing the lock lever toward an engaged position.

10. The truck bed mounted carrier system of claim 7, further comprising a tailgate bump plate coupled to the at least one transport stand, wherein the tailgate bump plate includes the lock pin and is configured to engage with the lock lever to lock the at least one transport stand in the deployed position.

11. The truck bed mounted carrier system of claim 1, further comprising: a lower bed rail strut adjustably coupled to the at least one lateral support; an upper bed rail strut adjustably coupled to the lower bed rail strut; and an inner support tube lock configured to secure the upper bed rail strut relative to the lower bed rail strut.

12. The truck bed mounted carrier system of claim 11, wherein the inner support tube lock comprises: a base plate having at least two slots; a base plate support coupled to the lower bed rail strut; a pinch plate partially inserted into the at least two slots of the base plate; a finger tab formed on the pinch plate; a thumb tab formed on the base plate; and a compression spring positioned between the finger tab and the thumb tab, wherein the pinch plate creates at least one pinch point against the upper bed rail strut to secure the upper bed rail strut in position.

13. The truck bed mounted carrier system of claim 11, wherein the upper bed rail strut includes an attachment member configured to be removably coupled to an inside upper panel of the truck bed.

14. The truck bed mounted carrier system of claim 1, wherein the at least one inner support is coated with a low-friction material selected from the group consisting of Delrin, PTFE, nylon, and ultra-high-molecular-weight polyethylene.

15. The truck bed mounted carrier system of claim 1, further comprising: a first slide coupled to the at least one radius support and configured to move along the at least one outer main support; a second slide coupled to the carrier frame and configured to move along the at least one radius support; and a third slide coupled to the carrier frame and configured to move along the second inner support.

16. The truck bed mounted carrier system of claim 15, wherein the second slide comprises: a bearing support; a bushing bracket; a pivot shaft; at least one roller; and at least one bushing plate, wherein the at least one roller is rotationally coupled to the at least one bushing plate by a bushing shaft.

17. The truck bed mounted carrier system of claim 1, wherein the carrier frame includes at least one carrier handle on an aft side of the carrier frame, the at least one carrier handle having a grip surface to facilitate manual extension and retraction of the carrier frame.

18. The truck bed mounted carrier system of claim 1, wherein the at least one lateral support includes at least one wheel positioned at each corner of the frame assembly to facilitate placement of the truck bed mounted carrier system into the truck bed.

19. The truck bed mounted carrier system of claim 2, wherein the at least one gas spring has an extension force between 100 pounds and 400 pounds.

20. The truck bed mounted carrier system of claim 3, wherein the mechanical drive assembly has a lever to gear force ratio of 5:1.
